(19) United States
(12) Patent Application Publication
(10) Pub. No.: US 2022/0072874 A1
(43) Pub. Date: Mar. 10, 2022

(54) Offset Swing Arm for Changing Relative Nip Speeds

(71) Applicant: Lexmark International, Inc., Lexington, KY (US)

(72) Inventors: RONALDO MANINGAS CALAPIS, Cebu City (PH); DANIEL GILCHRIST GUERAND, Lexington, KY (US)

(21) Appl. No.: 17/528,945

(22) Filed: Nov. 17, 2021

Related U.S. Application Data
(63) Continuation of application No. 17/225,388, filed on Apr. 8, 2021, now abandoned.
(60) Provisional application No. 63/009,353, filed on Apr. 13, 2020.

(51) Int. Cl. B41J 11/00; B41J 11/04; B41J 3/60

(52) U.S. Cl. CPC B41J 11/006; B41J 3/60; B41J 11/04

(57) ABSTRACT

The invention which solves the relative speed problem between nips in a printing system is disclosed. The invention consists of a swing arm body that rotates about a pivot, an input drive gear, a forward swing arm gear, two reverse swing arm gears, a compound duplex drive gear, and a housing.

### CROSS REFERENCES TO RELATED APPLICATIONS

This application is a continuation application of U.S. patent application Ser. No. 17/225,388, filed Apr. 8, 2021, entitled “Offset Swing Arm for Changing Relative Nip Speeds.”

### BACKGROUND

### 1. Field of the Invention

This invention relates generally to operation of media nips in a printing system.

### 2. Description of the Related Art

In a printing system it is necessary that adjacent media nips (a nip is where two rollers meet), often consisting of a drive roll and a backup roll, operate at critical speeds relative to each other. The critical, relative speeds are necessary because they will dictate the media behavior in between the adjacent nips.

One way in which this problem has been addressed in the past is with the use of an additional motor. For example, a separate motor may be used to drive both the fuser nip and output nip. In such an embodiment the fuser and output rolls are tied together by a gear train. By doing this, the relative speed of the output and fuser nips can be tied together using gear ratio and roll diameter. After the media leaves the fuser nip the motor speed can be adjusted such that the output nip speed is matched to the duplex nip speed. This is possible because the duplex rolls and output rolls are driven by separate motors. The problem with this embodiment is the cost and noise associated with adding an additional motor to the system. Note that an additional motor typically is not added to specifically address this problem identified here. However, when a motor is added for other reasons, this problem may be solved in the that process.

Another way this problem has been addressed is by accepting the risk of having an unwanted speed mismatch between adjacent nips. Here, the duplex rolls could be sized such that the two duplex nips match the speed of the output nip. The duplex roll could be sized such that duplex nip matches the speed of the input and photoconductor nips. However, this approach creates a speed mismatch between duplex nips. In other words, when the media enters duplex nip it will try to pull the media through the prior duplex nips. This stretching will cause drag on the media. The drag can lead to the media slipping in the upstream nips. This is especially true if the media is going around a turn. Drag will also produce an unwanted torque on the media, causing it to skew. The speed mismatch at the duplex nips may or may not cause a performance issue, but it is certainly not desirable.

Thus, there is a need to allow the use the reversal of the main motor to reverse the paper for the duplex operation while simultaneously preserving the reversing of the photoconductor drum a precise amount. Hence, an expensive solenoid is removed from the printer platform to save additional costs significantly.

### SUMMARY OF THE INVENTION

In a printing system it is necessary that adjacent media nips operate at critical speeds relative to each other. The critical, relative speeds are necessary because they will dictate the media behavior in between the adjacent nips.

The invention disclosed herein solves the relative speed problem by using a swing arm body that rotates about a pivot engaging a forward swing arm gear or two reverse swing arm gears off an input drive gear according to the direction desired during duplexing.

### BRIEF DESCRIPTION OF THE DRAWINGS

Having thus described the invention in general terms, reference will now be made to the accompanying drawings, which are not necessarily drawn to scale, and wherein:

FIG. 1 shows a printing system with nips, and three types of media behavior.

FIG. 2 shows a printing system with one motor that drives a duplexing system.

FIG. 2A shows a printing system with one motor that drives a duplexing system showing the paper path.

FIG. 3 shows the gearing of the swing arm mechanism.

FIG. 3A shows the swing arm mechanism with respect to the input drive gear.

FIG. 3B shows the duplex drive gear in isolation.

FIG. 3C shows the input drive gear and duplex drive gear in isolation.

FIG. 3D shows a rear isometric view of the input drive gear in isolation

FIG. 4 shows a top view of the swing arm mechanism with respect to the input drive gear.

FIG. 5A shows swing arm mechanism with the forward swing arm gear engaged.

FIG. 5B shows swing arm mechanism with the rear swing arm gear engaged.

FIG. 6 shows a top view of the forward and rear swing arm gears and the offset.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology, terminology and dimensions used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having” and variations thereof herein is meant to encompass the items listed thereafter and equivalents thereof as well as additional items. Terms such as “about” and the like are used to describe various characteristics of an object, and such terms have their ordinary and customary meaning to persons of ordinary skill in the pertinent art. The dimensions of the magnetic particles, separations between particles and sensor locations are interrelated and can be proportionally scaled with respect to each other to provide different sized solutions.

The present invention is described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

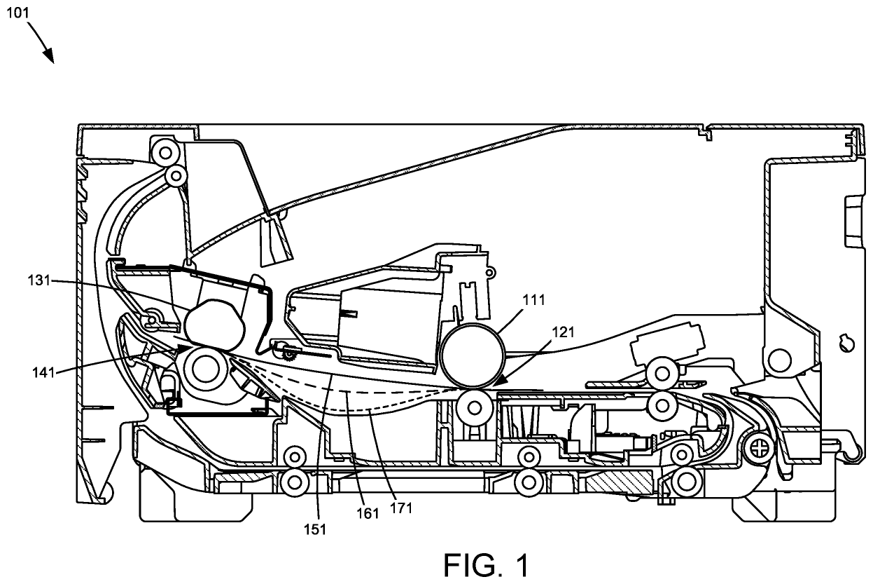

In a printing system it is necessary that adjacent media nips (a nip is where two rollers meet), often consisting of a drive roll and a backup roll, operate at critical speeds relative to each other. The critical, relative speeds are necessary because they will dictate the media behavior in between the adjacent nips. The relative speed of a nip refers to its speed with respect to another given nip. In general, there are three types of media behavior in between adjacent nips. These behaviors are bubble, tension, and match. A bubble could be created if, for example, to ensure the media is not pulled or tugged through an upstream nip. This tugging can create print quality issues if the upstream nip happens to be a where toner is transferred to the media. On the other hand, tension could be created to ensure the media is tugged through the upstream nip, e.g., to de-curl the paper if it is coming through the fuser. The two parameters that affect the relative roll speeds are drive roll diameter and gear ratio. FIG. 1 shows a printer 101 with a photoconductor nip 121 along with a fuser nip 141, respectively, associated with the photoconductor roller 111 and the fuser roller 131, in an electrophotographic printer. The three types of media behavior; bubble, tension and match are also shown and labeled 171, 151, and 161, respectively.

In some printing systems a single motor is used to drive all the rollers, also referred to as rolls, in that system as well as reverse the direction of the rollers when duplexing the media. Use of a single motor is desirable for keeping the cost and noise level of the system down. However, in a printing system that uses a single motor there is inevitably going to be a set of rolls that need to have its roll speed changed to maintain the critical relative nip speeds mentioned above.

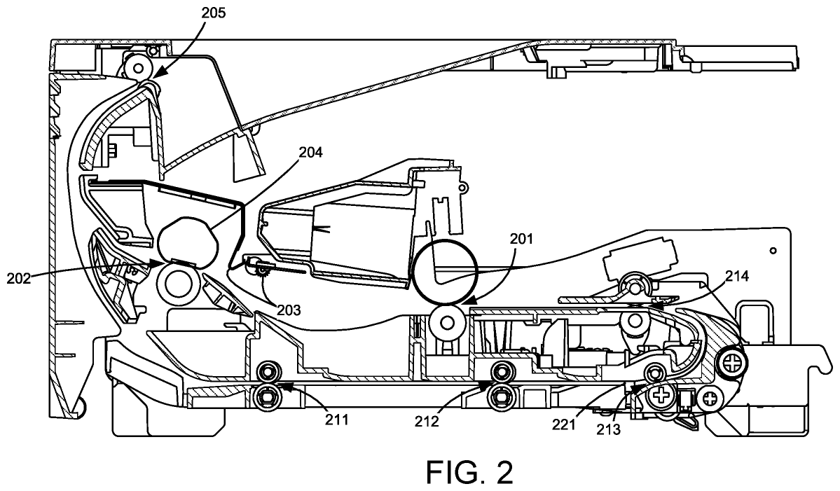

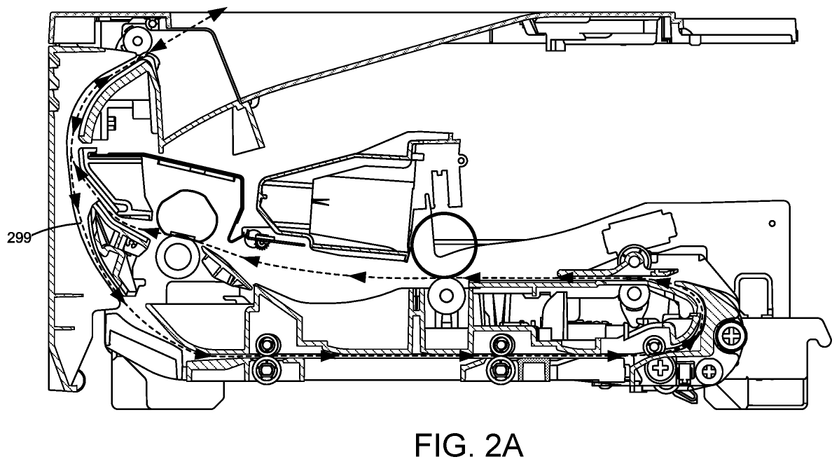

One example of a system that uses a single motor is shown in FIG. 2. The motor drives all the rolls along the paper path 299 in FIG. 2A, and changes direction when the media is duplexed (printed on both sides). The photoconductor nip is labeled 201. At the photoconductor nip 201, the toner image is transferred from the photoconductor drum to the media. The fuser nip is labeled 202. At the fuser nip 202, the toner image is fused into the media. The relative speed of the fuser nip 202 with respect to the photoconductor nip 201 is critical to properly transfer and fuse the toner image onto and into the media, respectively. Typically, the fuser nip speed is slower than the photoconductor nip speed in order to build a bubble 171 between the two nips 201, 202. This bubble 171 will ensure the media is not being tugged between the two nips 201, 202, potentially disturbing the image as it is being transferred to the media. The bubble 171 will also keep the image away from the fuser entry deflector and fuser belt as the media enters the fuser (not shown). If the image touches the deflector or belt it will disturb the image and create a print defect. The fuser entry deflector and belt are labeled 203 and 204, respectively. The relative speed of the output nip, labeled 205, with respect to the fuser nip 202 is also critical. These nip speeds need to match as no bubble or tension is desirable between these nips. Therefore, the output roll diameter at 205 is sized, and its gear ratio is set to achieve this speed match. This also means that the output nip 205 will be running slower than the photoconductor nip. During duplexing, the output nip will reverse direction, and the media will head toward the duplex nips; labeled 211, 212 and 213. The relative speed of output nip 205 with respect to the first two duplex nips, 211 and 212, must also match as, again, no bubble or tension is desirable between these nips. The duplex nips 211, 212, 213 must therefore match the speed of the output nip 205 when the paper is entering duplex. Once the media has left the output nip 205 and reaches the point labeled 221, the motor is stopped and reversed. For the embodiment shown in FIG. 2, duplex nips 211 and 212 are driven off the invention discussed in this paper. The duplex nip 213 is driven off a separate section of the gear train. Therefore, the media must stop at point 221. However, the invention being discussed could also drive duplex nip 213. When the motor reversal takes place, it is necessary to increase the speed at duplex nips 211 and 212. This is necessary because the speed of duplex nips 211 and 212 with respect to duplex nip 213 and the input nip, labeled 214, is critical. The duplex drive roll at 213 and input drive roll diameter at 214 are sized, and the gear ratios are set to match the speed of the photoconductor nip 201. The speed match between the photoconductor nip 201 and input nip 214 is critical so as not to disturb the image during toner transfer to the media. Thus, the problem lies the in the duplex module, which is a subsystem of the printer that includes the paper path, feed rolls, deflectors, gears, and any other hardware associated with duplexing the paper. In the case where the media is entering the duplex module, the duplex drive nips 211, 212, 213 must match the speed of the fuser 202 and output 205 nips. When media is exiting the duplex module, the duplex nips 211, 212, 213 must match the speed of the input 214 and photoconductor 201 nips. The invention covered in this document solves the problem.

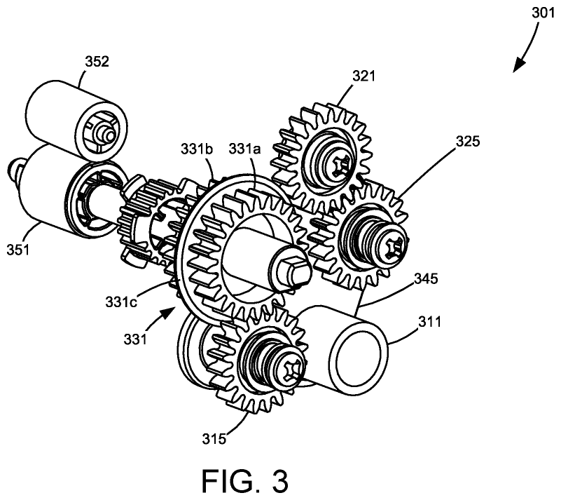

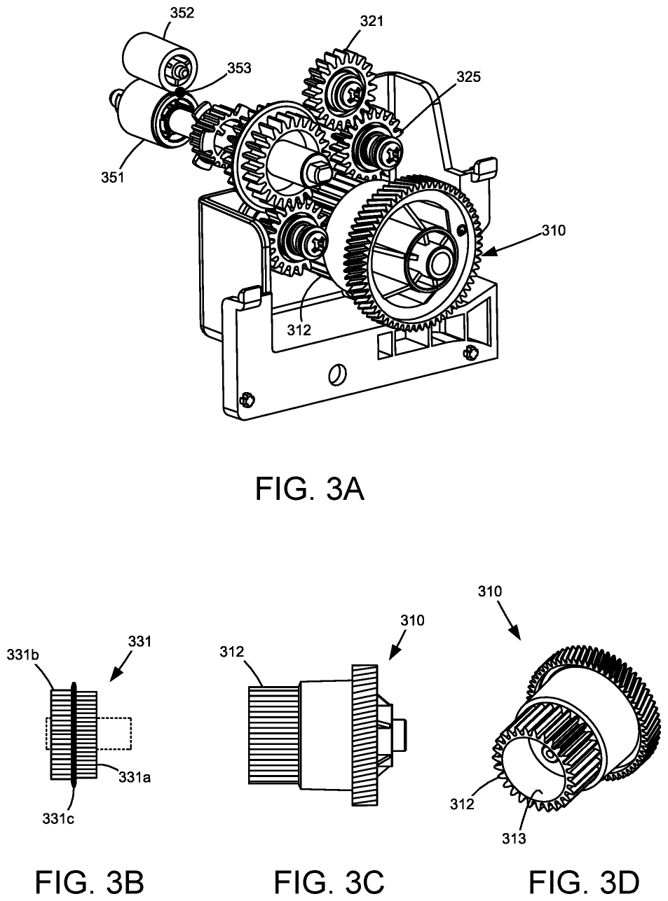

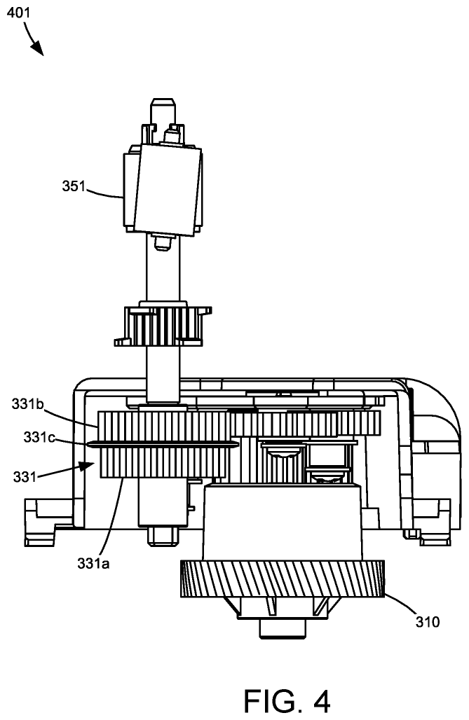

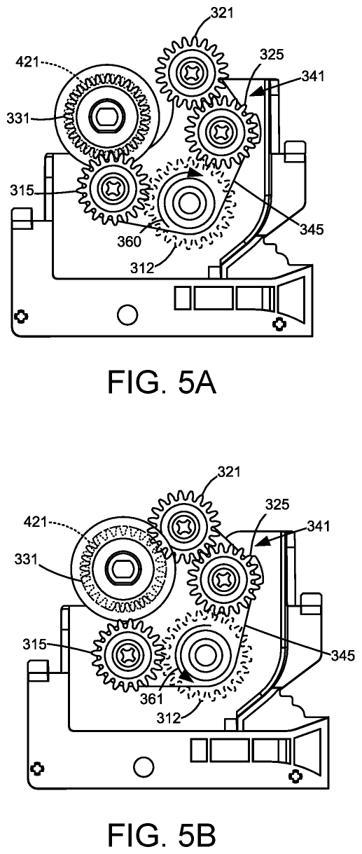

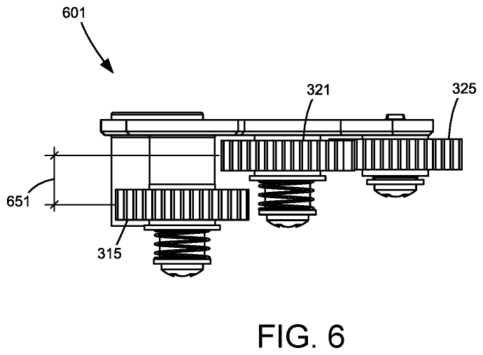

The invention which solves the relative speed problem is shown, in detail, in FIGS. 3 and 3A. The invention consists of a swing arm body 345 (see also, FIGS. 5A and 5B), that rotates about a pivot 311, an input drive gear 312, a forward swing arm gear 315, two reverse swing arm gears 321, 325, a compound duplex drive gear 331, and a housing 341. The duplex drive roll is labeled 351. The nip 353 between the duplex drive roll 351 and the back-up roll 352 may be any one of nips 211, 212, 213, or any other nip where the drive direction is reversed. The compound duplex drive gear 331 consists of two gears 331A, 331B. These gears 331A, 331B have a different number of teeth on them and are shown in FIG. 3B. The compound duplex drive gear 331 may also be referred to as the duplex drive gear. This embodiment of the invention requires one swing arm gear 315 when the input drive gear 312 is rotating in the clockwise direction 360, shown in FIG. 5A. Two swing arm gears 321, 325 are required when the input drive gear 312 is rotating in the counter-clockwise direction 361, shown in FIG. 5B. The input drive gear 312 shown in FIG. 3C is driven by the duplex drive gear 310 from a motor (not shown). A person of ordinary skill in the art would understand that the driving mechanism could come from any source, and is not limited to the duplex drive 310 and motor. In FIG. 3D a rear isometric view of the input drive gear 312 is shown with an inner surface 313 that slides over the boss 311 that is part of the swing arm body 345. The use of one and two swing arm gears means that the duplex drive gear 331 and duplex drive roll 351 will always turn in the clockwise direction, regardless of which direction the input drive gear 312 is turning. However, this invention does not require that one and two swing arm gears are used. Embodiments that have any other combination of swing arm gears are also covered under this patent. The forward swing arm gear 315 is offset from the two reverse swing arm gears 321, 325 by a determined amount 651 as shown in FIG. 6. The duplex drive gear 331 may be a single part or a combination of parts which are attached to one another. In addition, features may or may not be added to the duplex drive gear 331 to enhance operation. In the embodiment shown in FIG. 3B, the disk feature 331C in the center of the duplex drive gear 331 helps guide swing arm gears 315 and 321 into engagement with duplex drive gears 331A and 331B, respectively.

Referring to FIG. 2, the media will travel from the output nip to the duplex nip, 205 and 211, respectively. In this stage, called the duplex stage, the input drive gear 312 is turning counter-clockwise and the swing arm is in the orientation shown in FIG. 5B. The tooth forces on the forward swing arm gear 315 and the reverse swing arm gear 321 will create reaction forces on the swing arm body 345 which cause it to rotate in the counter-clockwise direction. The rotation of the swing arm body 345 will cause the reverse swing arm gear, 321, to mesh with the duplex drive gear at 331B. While in this configuration the gear ratio going to the duplex drive roll, 351, is such that duplex nips 211 and 212 match speeds with the output and fuser nips, 205 and 202 respectively. The forward swing arm gear 315 is not engaged during this stage. When the media has left the output nip and reaches point 221, the input drive gear 312 stops and changes direction. In this stage, called the return stage, the input drive gear 312 is now turning clockwise, and the swing arm moves to the orientation shown in FIG. 5A. The tooth forces on the forward swing arm gear 315 and reverse swing arm gear 321 will create reaction forces on the swing arm body 345 that will cause it to rotate in the clockwise direction 360. The rotation of the swing arm body 345 will cause the forward swing arm gear 315 to mesh with the duplex drive gear at 331A. While in this configuration the gear ratio going to the duplex drive roll, 351, is such that duplex nips 211 and 212 match speeds with the duplex, input, and photoconductor nips, 213, 214, and 201 respectively. The reverse swing arm gear 321 is not engaged during this stage. The swing arm components, 345, 315, 321, 325, 331 therefore, successfully changes the speed of the duplex drive nips by changing the gear ratio going to those nips.

We claim:

1. An offset swing arm device for a printer duplex module comprising:
a swing arm body;
an input drive gear;
one or more forward swing arm gears;
one or more reverse swing arm gears;
a compound duplex drive gear; and
a housing, wherein the compound duplex drive gear consists of two gears that have a different number of teeth.

2. The offset swing arm device of claim 1, wherein the forward swing arm gears and the reverse swing arms gears are offset.

3. The offset swing arm device of claim 1, wherein there is one forward swing arm gear and two reverse swing arm gears.

4. The offset swing arm device of claim 1, wherein the forward swing arm gear and the reverse swing arms gears are offset.

5. The offset swing arm device of claim 1, wherein when one swing arm gear is rotating in a first direction when the input drive gear is rotating in the first direction, while two swing arm gears rotate in a second direction when the input drive gear is rotating in the second direction.

6. The offset swing arm device of claim 5, wherein the compound duplex drive gear and roll will always turn in the first direction, regardless of which direction the input drive gear is turning.
